(19) United States
(12) Patent Application Publication
(10) Pub. No.: US 2020/0127864 A1
(43) Pub. Date: Apr. 23, 2020

(54) Method and Apparatus for Providing Service Authorization to a Charging Client Function

(71) Applicant: Telefonaktiebolaget LM Ericsson (publ), Stockholm (SE)

(72) Inventors: Simon Norberg, Karlskrona (SE); Niklas Bertilsson, Karlskrona (SE); Erik Milendahl, Karlskrona (SE)

(21) Appl. No.: 16/463,992

(22) PCT Filed: Dec. 22, 2016
(86) PCT No.: PCT/SE2016/051310

§ 371 Date: May 24, 2019

Related U.S. Application Data
(60) Provisional application No. 62/429,248, filed on Dec. 2, 2016.

(51) Int. Cl. H04L 12/14; G06Q 20/12; G06Q 20/40

(52) U.S. Cl. CPC H04L 12/1421; G06Q 20/127; H04L 12/1457; H04L 12/1428; G06Q 20/40

(57) ABSTRACT

Methods, systems, a computer program and a computer program product for providing service authorization to a Charging Client function which comprises associating one or more charging modifier actions with a user account, each charging modifier actions having an action start time and defining a charging modifier parameter and receiving a service authorization request indicating a request for service reservation from a charging client. A validity time period for the service reservation is determined; one or more of the associated charging modifier actions having the action start time within the determined validity time period is identified; the identified one or more associated charging modifier actions are executed to activate the charging modifiers for the user account and a service authorization response indicating a service reservation to the charging client is sent, the service reservation based on at least one of the activated charging modifiers.

### TECHNICAL FIELD

The present solution relates to methods, systems, a computer program and a computer program product for providing service authorization to a Charging Client function.

### BACKGROUND

In an Online Charging System (OCS), all costs are reserved from a subscriber account before actual usage in order to avoid over usage, i.e. that a user is allowed to spend more resources than purchased. An OCS will typically reserve cost for a validity time of anything between 1 minute and 24 hours. Any actions on the account triggered externally, from for example an administrative system during this period will be unable to affect the ongoing sessions that already have been reserved. In Diameter Credit-Control Application, IETF RFC 4006, this issue is solved by Server-Initiated Credit Re-Authorization making it possible for the OCS to require all sessions to report usage and performing a new reserve based on the new subscriber data. The solution with Server-Initiated Credit Re-Authorization forces all ongoing session for a subscriber to report usage early and will thus trigger additional signaling in the network.

Certain communication services may be offered to the subscribers of a given communication network according to product offerings. For example, mobile broadband connectivity may be offered to individual subscribers of a cellular or other wireless or wired communication network in defined blocks of time, e.g., hourly. Alternatively, the product offering may be based on discrete blocks of data transfer amounts. For example, the product in question comprises one (1) day of data connectivity, which may be subject to a usage cap, or the product comprises one (1) Gigabyte of data connectivity, which may be subject to a defined validity period or expiration time. A product offering holds an amount of resources and could be valid for a limited time. Examples of product offerings could be: a volume of 2 GB allowed Data transmission valid for one month or free calls for 24 hours.

While the telecommunications network could pre-provision such offered products for all or some of its subscribers, doing so imposes undesirable complexity and resource overhead, as a consequence of the need for creating, tracking, and reconciling the pre-provisioned products. As an alternative, so called “temporary products” that are provisioned speculatively for given users, e.g., in response to a charging trigger or on some other basis may be utilized. For example, the telecommunications network may provision a temporary data-usage product for a subscriber, on a speculative basis. If the subscriber uses all or part of the temporary product, the product appropriate charging records are generated. Otherwise, the temporary product expires, and the associated database entries are deleted. The U.S. Pat. No. 9,204,280 B2 provides example details regarding temporary products, and their creation in the context of service-triggered provisioning.

If the external action is to create a new offering on all subscribers at the same time, then all ongoing sessions would need to report usage at once and risk overloading the network.

If the external system instead creates the offering, already before it should be valid, it is possible to avoid extra signaling, since the OCS can see that the offering will become active when doing the reservation. However, this early creation voids the possibility to charge a fee to the subscriber when this new offering becomes valid, since that would force deduction of the fee already before the subscriber could use the new offering and those running the risk of blocking services that the subscriber expects funds on the account to last for.

When an external system creates an offering and charges a fee over an administrative interface that allows deduction of reserved funds, it runs the risk of deducting funds that is already reserved, and could have been used by another service, causing service outage for the user and revenue loss for the operator. If the external system instead uses an interface that does not allow deduction of reserved funds, it runs the opposite risk, that it is unable to deduct the fee since ongoing sessions have reserved the funds. However, these sessions might not necessarily use the reservations with the result that funds have been unnecessarily locked up resulting in less available additional services for the user.

U.S. Pat. No. 9,264,557B2 discloses an operation method used in node of telecommunications charging system involves permitting use of all of telecommunication services associated with product instance during product instance lifecycle without posting further fee. A solution is described which can deduct a fee the first time an offering is used in a charging request. The offering is required to already have been provisioned. If no charging request occurs during the validity of the offering the fee will not be deducted.

As described previously U.S. Pat. No. 9,204,280B2 discloses a method and apparatus for charging product-related services in a communication network which can create an offering when a charging request is received. Some charging activity on the subscriber is thereby needed for the offering to be created. If no charging activity occurs during the period that the offering could be created, then the offering will not be created, nor will any connected fee be deducted. The fact that the offering is not created until a charging request is received also means that any notifications that is to be sent will be delayed until a charging request is received or indefinitely if no charging request is received.

### SUMMARY

It is an object of the invention to provide a method, an Online Charging System, a computer program and a computer program product for providing service authorization to a Charging Client in order to alleviate at least some of the disadvantages set out above.

A first aspect of the invention relates to a method performed by an Online Charging System for providing service authorization to a Charging Client. The method comprises associating one or more charging modifier actions with a user account, each charging modifier actions having an action start time and defining a charging modifier parameter and receiving a service authorization request indicating a request for service reservation from a charging client. The method further comprise determining a validity time period for the service reservation; identifying one or more of the associated charging modifier actions having the action start time within the determined validity time period; executing the identified one or more associated charging modifier actions to activate the charging modifiers for the user account and sending a service authorization response indicating a service reservation to the charging client, the service reservation based on at least one of the activated charging modifiers.

An advantage is that thus that there is no need to perform any extra signaling when the new offering is created, since products that will be active later may be considered by the OCS already during the reserve phase.

A second aspect of the invention relates to an Online Charging System for providing service authorization to a Charging Client. The Online Charging System is adapted to associate one or more charging modifier actions with a user account, each charging modifier actions having an action start time and defining a charging modifier parameter and to receive a service authorization request indicating a request for service reservation from a charging client. The Online Charging system is further adapted to determine a validity time period for the service reservation; to identify one or more of the associated charging modifier actions having the action start time within the determined validity time period; to execute the identified one or more associated charging modifier actions to activate the charging modifiers for the user account and to send a service authorization response indicating a service reservation to the charging client, the service reservation based on at least one of the activated charging modifiers.

A third aspect of the invention relates to an Online Charging System for providing service authorization to a Charging Client. The Online Charging System is comprising an association module for associating one or more charging modifier actions with a user account, each charging modifier actions having an action start time and defining a charging modifier parameter and a receiving module for receiving a service authorization request indicating a request for service reservation from a charging client. The Online Charging System is further comprising a determination module for determining a validity time period for the service reservation; an identifier module for identifying one or more of the associated charging modifier actions having the action start time within the determined validity time period; an execution module for executing the identified one or more associated charging modifier actions to activate the charging modifiers for the user account; and a transmission module for sending a service authorization response indicating a service reservation to the charging client, the service reservation based on at least one of the activated charging modifiers.

A fourth aspect of the invention relates to an Online Charging System for providing service authorization to a Charging Client. The Online Charging System is comprising a processor circuitry and a memory containing instructions that, when executed by the processor circuitry, cause the Online Charging System to associate one or more charging modifier actions with a user account, each charging modifier actions having an action start time and defining a charging modifier parameter and to receive a service authorization request indicating a request for service reservation from a charging client. The memory is further containing instructions that cause the Online Charging System to determine a validity time period for the service reservation; identify one or more of the associated charging modifier actions having the action start time within the determined validity time period; execute the identified one or more associated charging modifier actions to activate the charging modifiers for the user account and send a service authorization response indicating a service reservation to the charging client, the service reservation based on at least one of the activated charging modifiers.

A fifth aspect of the invention relates to a computer program containing comprising computer readable code means, which when run in a computer being configured as an Online Charging System the computer readable code means causes the computer to perform the steps of associating one or more charging modifier actions with a user account, each charging modifier actions having an action start time and defining a charging modifier parameter and receiving a service authorization request indicating a request for service reservation from a charging client. The computer readable code means also causes the computer to perform the steps of determining a validity time period for the service reservation; identifying one or more of the associated charging modifier actions having the action start time within the determined validity time period; executing the identified one or more associated charging modifier actions to activate the charging modifiers for the user account and sending a service authorization response indicating a service reservation to the charging client, the service reservation based on at least one of the activated charging modifiers.

A sixth aspect of the invention relates to a computer program product comprising a computer readable medium and a computer program, as described in the preceding paragraph, stored on the computer readable medium.

Embodiments of the invention will now be described in more detail and with references to the enclosed drawings.

### BRIEF DESCRIPTION OF THE DRAWINGS

FIG. 1 is a block diagram showing an Online Charging System according to the present solution.

FIG. 2 shows the result according to prior art solutions, if an external admin system provisions the offerings where the OCS is not able to take future offerings into consideration for the reservation.

FIG. 3 shows how the present solution improves the situation of FIG. 2 by making the OCS aware of future offerings that will be created.

FIG. 4 is a flowchart showing how a session or event is reserved according to the present solution.

FIG. 5 is a sequence diagram showing how a scheduled action is provisioned towards the OCS by an administrative system.

FIG. 6 is a sequence diagram showing the handling of when units are reported after usage.

FIG. 7 is a sequence diagram showing how reporting of no usage is handled, i.e. where the reserved action is not used and is removed.

FIG. 8 is a flow chart showing how to handle multiple sessions that want to reserve the same scheduled action.

FIG. 9 is a block diagram showing an exemplary embodiment of an Online Charging System according to the disclosed solution.

FIG. 10 shows a computer program product, comprising a non-transitory computer readable medium and a computer program stored on the computer readable medium.

FIG. 11 shows a method performed by an Online Charging System for providing service authorization to a Charging Client.

### DETAILED DESCRIPTION

In the present solution both a created offering and/or a connected fee is reserved within the Online Charging System (OCS). This reservation enables the OCS to consider offerings and fees that will occur in the future already during the reservation phase of an event. The reserved offering stores an identifier, start time, end time and balance of the offering. The balance may be in the form of monetary funds and/or as some other resource such as data volume or number of SMS:s. The reserved fee, if used, stores which offering it is connected to, and how much that has been reserved for the fee on different accounts. As an example a reservation of an offering with 1 GB data, valid for 24 hours with a cost of 1 euro could be stored as:

Reserved Offering: [Identifier: 1|Resource: 1 GB Data| Start time: 2016-08-16 00:00|End time: 2016-08-17 00:00]

[Reserved Fee:Connected-Offering: 1|Reserved cost: 1 euro @ Account 12]

The reserved offering will be stored together with a start time of the offering, allowing the OCS to use the reserved offering when reserving sessions that will be ongoing when the new offering becomes valid.

The solution allows for both creating and charging for a single offering at one specific time, as well as having new offerings created and charged recurrently by specifying an associated schedule.

Thus, the OCS stores the information needed to see which offerings that will be created in the future. With the help of this information, the OCS can see which new offerings that will be created during the reservation phase and can take them into consideration.

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details disclosed below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in a non-transitory computer readable medium and so executed by a computer or processor, whether or not such computer or processor is explicitly shown.

The functions of the various elements including functional blocks, including but not limited to those labeled or described as “computer”, “processor” or “controller” may be provided through the use of hardware such as circuit hardware and/or hardware capable of executing software in the form of coded instructions stored on computer readable medium. Thus, such functions and illustrated functional blocks are to be understood as being hardware-implemented and/or computer-implemented, (e.g., machine-implemented).

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions.

In terms of computer implementation, a computer is generally understood to comprise one or more processors, or one or more controllers, and the terms computer and processor and controller may be employed interchangeably herein. When provided by a computer, processor, or controller, the functions may be provided by a single dedicated computer, processor, or controller, by a single shared computer, processor, or controller, or by a plurality of individual computers, processors, or controllers, some of which may be shared or distributed. Moreover, use of the term “processor” or “controller” shall also be construed to refer to other hardware capable of performing such functions and/or executing software, such as the example hardware recited above.

The technology may be used in any type of cellular radio communications (e.g., GSM, CDMA, 3G, 4G, etc). For ease of description, the term user equipment (UE) encompasses any kind of radio communications terminal/device, mobile station (MS), PDAs, cell phones, laptops, etc.

Referring now more particularly to the drawings in which like reference numerals indicate like parts throughout the several views.

This solution describes how an OCS can create new offerings and optionally deduct a fee on a scheduled time in a way that allows the reservation mechanism in the OCS to consider these offerings.

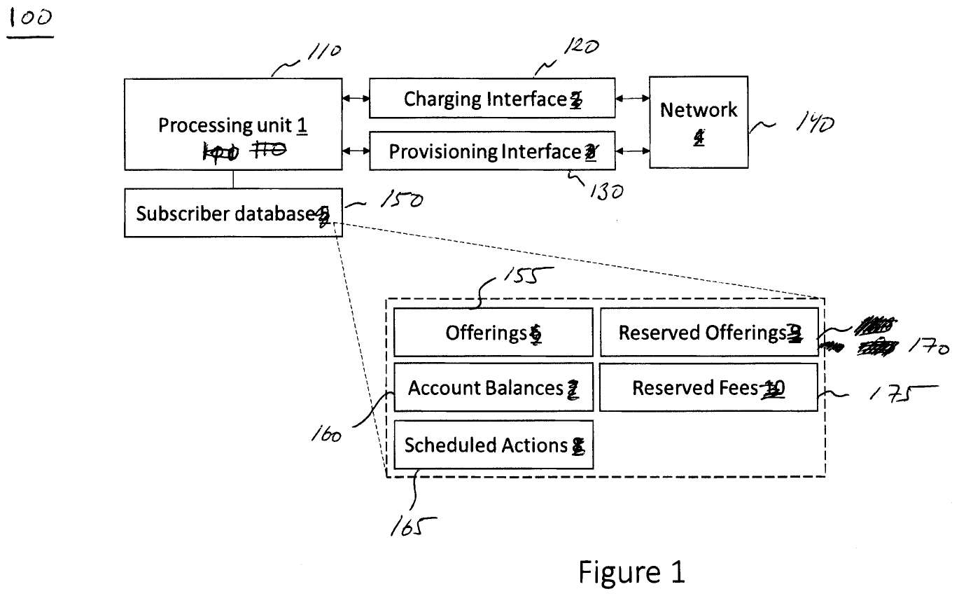

FIG. 1 is a block diagram showing an Online Charging System (OCS) according to the present solution.

The OCS 100 includes a processing unit 110, a charging interface 120 used by a Charging Client to trigger the OCS to reserve and charge for sessions and events, and a provisioning interface 130 which is used to provision the scheduled actions from an Administrative System towards the OCS. The charging interface 120 and the provisioning interface 130 communicate with Charging Clients and Administrative System using an external network 140.

The system has a subscriber database 150 where all resources for the subscriber are stored. These resources include offerings 155, account balances 160, scheduled actions 165, reserved offerings 175 and reserved fees 175.

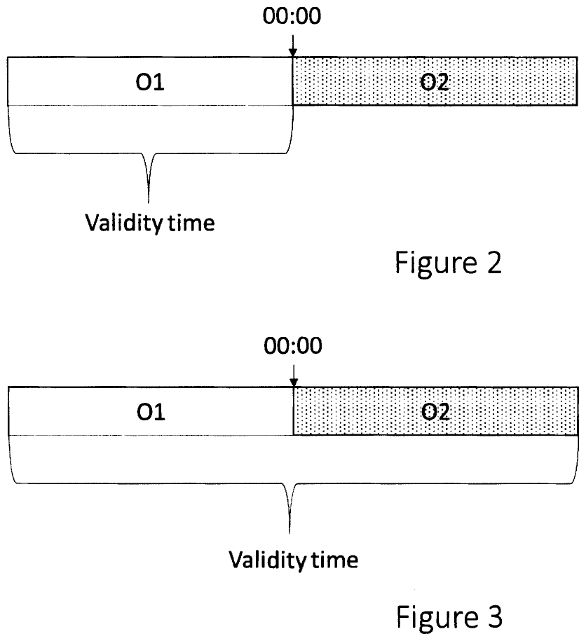

FIG. 2 shows the result according to prior art solutions, if an external admin system provisions the offerings where the OCS is not able to take future offerings into consideration for the reservation.

FIG. 1 shows one offering O1 that expires at time 00:00 and where another offering O2 will be provisioned by an external system at 00:00. When a session does a reservation prior to 00:00, no offering exists that is valid after 00:00, causing the OCS to limit the validity of the session to 00:00. As an example, O1 and O2 may each be offerings with 1 GB data valid for 1 day.

FIG. 3 shows how the present solution improves the situation of FIG. 2 by making the OCS aware of future offerings that will be created.

While reserving a session that continues past 00:00, the OCS will do the reservation in 3 steps.

1. Reserve data on O1 until 00:00, when the next action will occur.
2. Reserve for the next scheduled action that creates O2, by creating a Reserved Offering for the offering and a Reserved Fee for any connected fee.
3. Reserve data on O2 after 00:00 where the new O2 offering exists.

Thereby, the OCS knows that offering O2 will be valid after 00:00, and can then grant a validity time past 00:00. O1 and O2 are offerings with 1 GB data valid for 1 day. This can be done since the OCS knows that an action will be executed at 00:00.

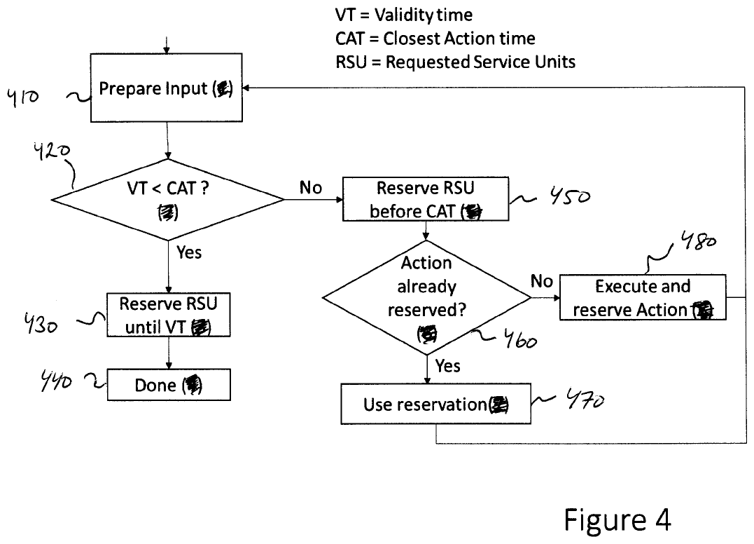

FIG. 4 is a flowchart showing how a session or event is reserved according to the present solution.

In step 410 a prepare of input for reservation is done. The requested validity time (VT) is fetched from the request, and the Closest Action Time (CAT) is calculated. CAT is calculated by going through all scheduled actions that the subscriber has and finding the next time each of them should be executed. The closest of these times is selected as CAT. If no scheduled actions exist on the subscriber, CAT is set to NOT_SET.

In step 420 it is determined if the validity time is closer than the closest action time. If that is not the case, CAT is set to NOT_SET and the method continues with step 450.

In case the validity time expires before the closest action time, the method continues with step 430 wherein the requested service units are reserved until the validity time VT resulting in that the session is reserved in step 440.

If the determination in 420 resulted in the validity time is closer than the closest action time the method continues in step 450 with reserving the Requested Service Units (RSU) for the time before CAT. Both RSU and/or the VT may have been received from the Charging Client in the incoming request (Decentralized Unit Determination and Centralized Rating) but may also be determined by the OCS (Centralized Unit Determination and Centralized Rating). In the present disclosure, these parameters will be referred to as RSU and VT irrespective of the source of determination.

In step 460 it is checked if the action has already been reserved, by checking if a Reserved Offering exists with the start time and offer identifier the scheduled action is configured to create. This is for example the scenario when a parallel session has already reserved the offering.

If the action has already been reserved the method continues in step 470 with that the existing reservation is used and made available for reserving units on in step 430 and 450.

If the action has not already been reserved the method continues in step 480 with executing and reserving the result of the action, which is a new Reserved Offering and optionally a Reserved Fee, and storing the reservations in the subscriber database.

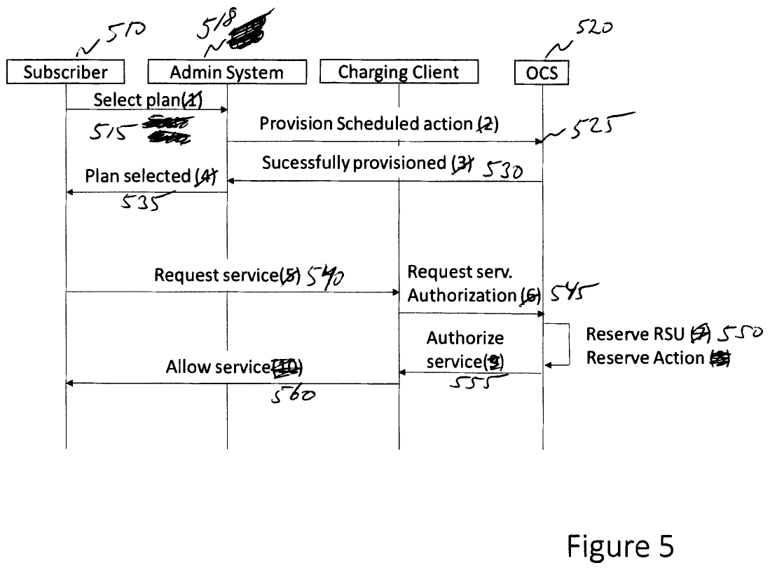

FIG. 5 is a sequence diagram showing how a scheduled action is provisioned towards the OCS by an administrative system.

A Scheduled Action contains:
What offering to create.
Fee to be paid for the offering, could be zero.
Start Time, when the offering should be created the first time.
Schedule, with what recurrence the offering should be created. If not set, the action will only create the offering once, at the time specified by start time.

Based on this data the OCS can know which new offerings that would be created by the scheduled action for the time period it is doing a reservation for. Any scheduled action that need to be executed during the reservation phase will also be reserved, so that other ongoing sessions for the same subscriber could re-use the same reservation.

FIG. 5 shows that the Subscriber 510 selects which plan he or she wants to have in step 515 using for example over the Internet using a self-service web interface, the admin system 518 then sends a request to the OCS 520 using an administrative interface which may be based on Remote Procedure Call RPC to create a scheduled action for the plan in step 525. The plan could for example be that for 25 euro/month the subscriber gets 5 GB data, 500 minutes calls, and 5000 SMS. The 25 euro is deducted from the subscribers account in the OCS. After the subscriber has used his monthly quota, he or she continues to pay per MB/minute/SMS. If the Scheduled action was successfully created, the OCS responds success to the Admin system in step 530, that can then inform the subscriber that the new plan is active in step 535, using the self-service web or other means of end user communication such as email or short message service SMS.

The next time the subscriber requests service, step 540, from the charging client, the client in turn sends a request to the OCS over a Diameter Interface to authorize the service in step 545. Diameter Charging Control is defined in RFC 4006 by the Internet Engineering Task Force IETF and has also been specified by the 3:rd Generation Partnership Project 3GPP in TS 32.299 V8.9.0 (2009-12). The request from the Charging client may thus be a Diameter CCR with CC-Request-Type AVP set to INITIAL_REQUEST to the OCS. If known, the charging client may include Requested-Service-Unit (RSU) AVP. The OCS will reserve the RSU in step 550 as well as any actions that occur during the requested validity time, and if enough funds exist the OCS will authorize the service in step 555. The OCS returns Diameter CCA message with CC-Request-Type set to INITIAL_REQUEST to the charging client in order to authorize the service execution with Granted-Service-Unit and Validity-Time (VT) AVP included in the CCA message. The charging client will then allow the service in step 560 wherein the content/service delivery starts.

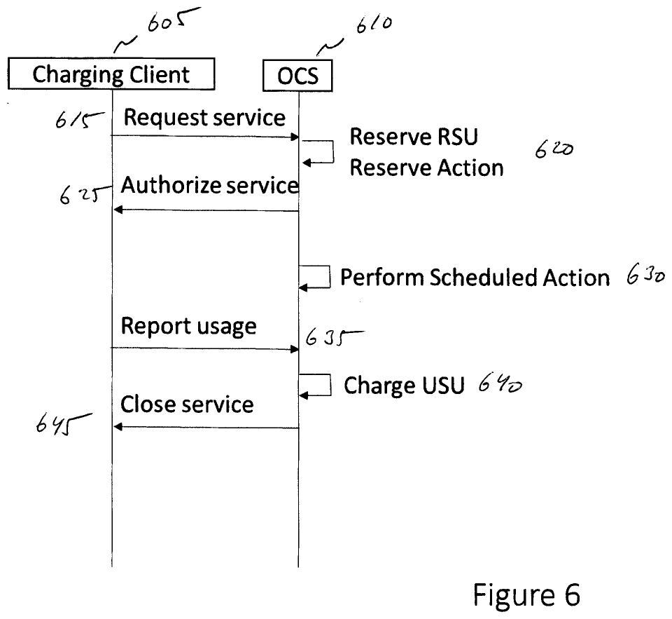

FIG. 6 is a sequence diagram showing the handling of when units are reported after usage.

FIG. 6 shows both the reserve and deduct phase of a charging session.

It starts with the Charging client 605 requesting service in step 615 sending a Diameter CCR with CC-Request-Type AVP set to INITIAL_REQUEST to the OCS. If known, the charging client may include Requested-Service-Unit (RSU) AVP. The OCS 610 will reserve the RSU and any actions that will occur during the validity time in step 620. The service is then authorized in step 625 by the OCS returning a Diameter CCA message with CC-Request-Type set to INITIAL_REQUEST to the charging client in order to authorize the service execution with Granted-Service-Unit and Validity-Time (VT) AVP included in the CCA message.

When it is time for the scheduled action to be performed in step 630, it is triggered internally in the OCS from the scheduled action. The OCS will check if there exists any reservation of the action, by checking if a Reserved Offering exists with the start time and offer identifier the scheduled action is configured to create. If there exists a reservation, it will make the Reserved Offering into a non-reserved offering, by creating an Offering with the same data as the Reserved Offering, and any Reserved Fees will be deducted from the account(s). If the offering is not already reserved the offering will be created directly and any connected fee will be deducted from the account(s).

With reference also to previously presented FIG. 1, a scheduled action 165 can be executed in two different ways. When a scheduled action is needed by a session doing reservation it will be executed and will create a reserved offering 170 if it is not already existing. When a scheduled action is to be executed in step 630, Perform scheduled action, it will create an Offering 155 either from scratch or from a previous Reserve Offering if such exists. If already existing, step 630 will remove the previous Reserved Offering. The Reserved Offering only exist as an indicator of that an Scheduled action have been reserved and with which resources. Service Units (time, volume etc.) is not reserved directly on the Reserved Offering, they are instead reserved and stored in a separate table in a subscriber database (not shown). The reservation contains how much units/money that is reserved, which session it is connected to, and which offering (regardless of it being a Reserved Offering or an Offering) and resource it is reserving. The reservation of service units is the same regardless of scheduled actions being used or not, and is mentioned only briefly as Reserve RSU in step 620.

Once the Charging Client charging session comes back to report usage in step 635 by sending a Diameter CCR with CC-Request-Type AVP set to TERMINATION_REQUEST to terminate the active Credit-Control session and reports the used units in the Used-Service-Unit (USU) AVP the action has already been executed by the OCS and the offering has been created. The charging of the Used Service Units (USU), in step 640, can therefore be done without needing to consider any scheduled actions.

Thereby, a service can be authorized before an offer is activated since the OCS knows that it will be—due to the scheduled actions being automatically executed at the right time a service offer is automatically activated. The service is then closed in step 645 by the OCS acknowledging the reception of the Diameter CCR message by sending CCA message with CC-Request-Type AVP indicating TERMINATION_REQUEST.

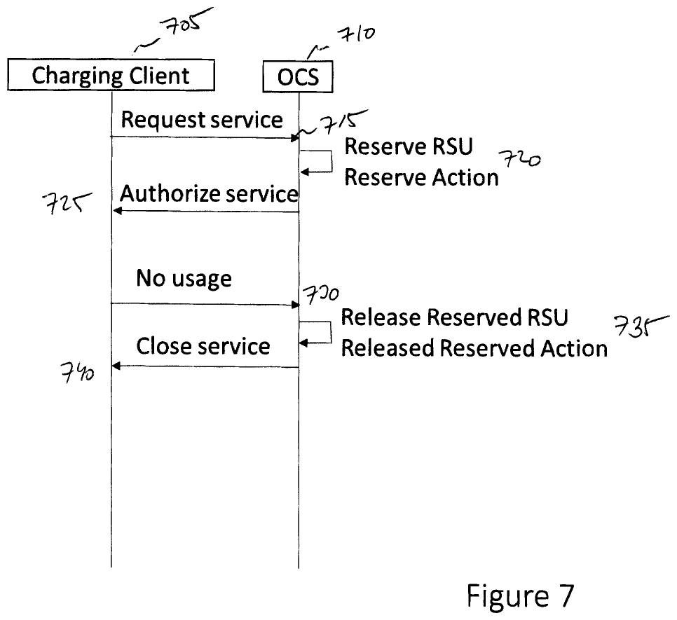

FIG. 7 is a sequence diagram showing how reporting of no usage is handled, i.e. where the reserved action is not used and is removed.

It starts with the Charging client 705 requesting service in step 715 by sending a Diameter CCR with CC-Request-Type AVP set to INITIAL_REQUEST to the OCS. If known, the charging client may include Requested-Service-Unit (RSU) AVP. The OCS 710 will reserve the RSU and any actions that will occur during the validity time in step 720. The service is then authorized in step 725 by the OCS returning a Diameter CCA message with CC-Request-Type set to INITIAL_REQUEST to the charging client in order to authorize the service execution with Granted-Service-Unit and Validity-Time (VT) AVP included in the CCA message.

In step 730 the charging client later reports that there is no usage and that the session should be closed by sending a Diameter CCR with CC-Request-Type AVP set to TERMINATION_REQUEST to terminate the active Credit-Control session and reports the the used units is zero in the Used-Service-Unit (USU) AVP. The OCS will then release the cost reserved for the RSU as well as any reserved actions that are not also reserved by any other sessions in step 735, and the service will be closed in step 740 by the OCS acknowledging the reception of the Diameter CCR message by sending CCA message with CC-Request-Type AVP indicating TERMINATION_REQUEST. It is also possible that there are reported units, and if the reported units are for a time before the reserved action(s), the reserved action(s) after that time are removed if no other session has reserved them.

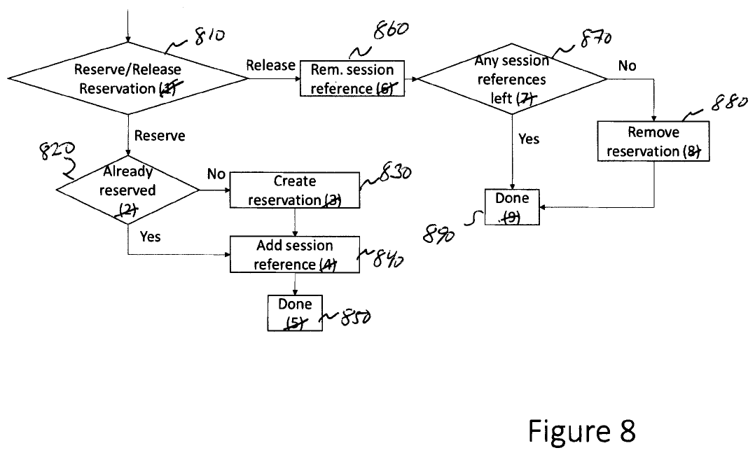

FIG. 8 is a flow chart showing how to handle multiple sessions that want to reserve the same scheduled action, where this solution allows all the sessions share one reservation. If none of the sessions ends up needing the reservation, it will be removed when the last of those sessions no longer needs the reservation.

In FIG. 8 it is shown how the OCS makes sure that the scheduled action is only reserved once, even when multiple sessions needs the action. FIG. 8 also shows that the reservation will be removed if there are no sessions that need the reservation.

The method starts with step 810 where it is checked if the session wants to make a reservation or to release a reservation. If a reservation was requested in step 810 it is checked in step 820 whether there already exists a reservation for the scheduled action. The reservation needed for the scheduled action is created in step 830 if no reservation exists. Could be both offerings and fees. In a step 840 directly following step 820, or if a reservation was created following step 830, a session reference is added to indicate that the reservation is used by this session and the sequence ends in step 850.

If it a release was requested in step 810 the session reference for this session is removed in step 860. The method continues in step 870 with checking if there are any session references left that connect to the reservation. If no such session references exist the reservation is removed in step 880 and the method ends in step 890. If session references are found to exist in step 870 the method ends directly with step 890.

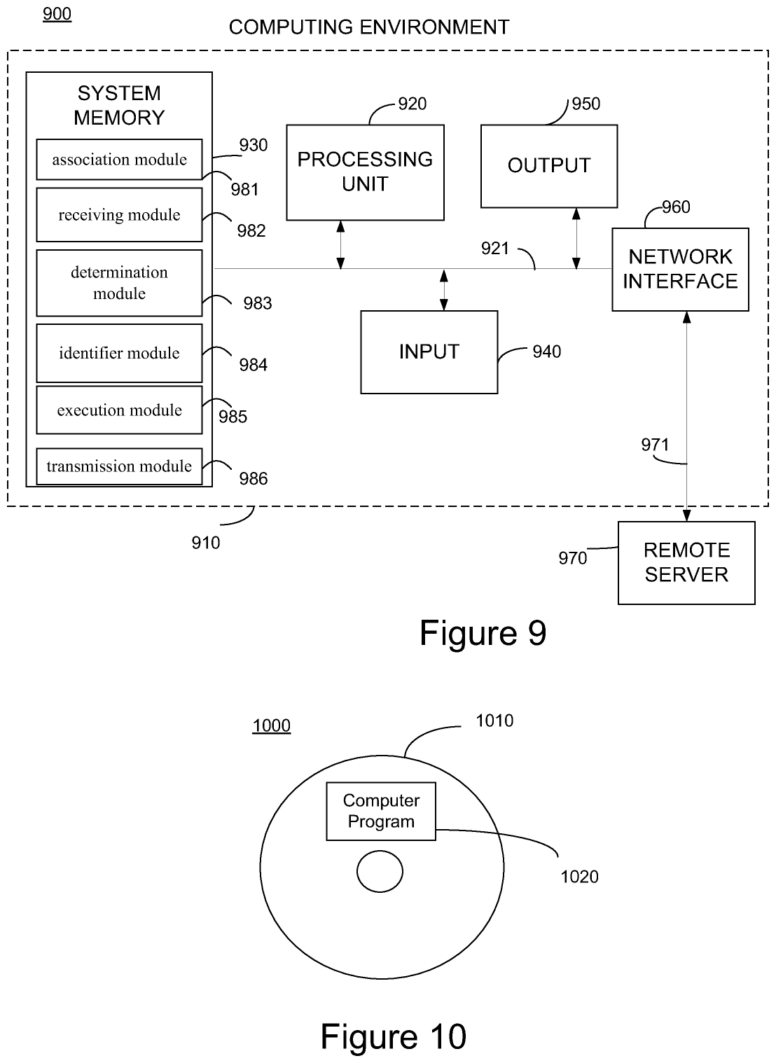

FIG. 9 is a block diagram showing an exemplary embodiment of an Online Charging System for providing service authorization to a Charging Client according to the disclosed solution in the form of computing system environment 900.

Although as made clear above, the computing system environment 900 is only one example of a suitable computing environment and is not intended to suggest any limitation as to the scope of use or functionality of the claimed subject matter. Further, the computing environment 900 is not intended to suggest any dependency or requirement relating to the claimed subject matter and any one or combination of components illustrated in the example operating environment 900.

An example of a device for implementing the previously described system includes a general purpose computing device in the form of a computer 910. Components of computer 910 can include, but are not limited to, a processing unit 920, a system memory 930, and a system bus 921 that couples various system components including the system memory to the processing unit 920. The system bus 921 can be any of several types of bus structures including a memory bus or memory controller, a peripheral bus, and a local bus using any of a variety of bus architectures.

Computer 910 can include a variety of transitory and non-transitory computer readable media. Computer readable media can be any available media that can be accessed by computer 910. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media can embody computer readable instructions, data structures, program modules or other data in a modulated data signal such as a carrier wave or other transport mechanism and can include any suitable information delivery media. FIG. 10 shows computer readable media in the form of a computer program product 1010 including a computer program 1720.

The system memory 930 can include computer storage media in the form of volatile and/or nonvolatile memory such as read only memory (ROM) and/or random access memory (RAM). A basic input/output system (BIOS), containing the basic routines that help to transfer information between elements within computer 910, such as during start-up, can be stored in memory 930. Memory 930 can also contain data and/or program modules that are immediately accessible to and/or presently being operated on by processing unit 920. By way of non-limiting example, memory 930 can also include an operating system, application programs, other program modules, and program data.

The system memory 930 may include a software module loaded in the memory and processable by the processing unit, or other circuitry which cause the online charging system to perform the steps described herein.

In particular, the system memory 930 may include a software module loaded in the memory and processable by the processing unit or other circuitry, which cause the Online Charging System for providing service authorization to a Charging Client to associate, for example by reserving, one or more charging modifier actions with a user account, each charging modifier actions having an action start time and defining a charging modifier parameter.

The software module further causes the OCS to receive a service authorization request indicating a request for service reservation from a charging client; to determine a validity time period for the service reservation; to identify one or more of the associated charging modifier actions having the action start time within the determined validity time period; to execute the identified one or more associated charging modifier actions to activate the charging modifiers for the user account and to send a service authorization response indicating a service reservation to the charging client, the service reservation based on at least one of the activated charging modifiers.

More particularly, the Online Charging System may include the following software modules for providing service authorization to a Charging Client:
an association module (981) for associating one or more charging modifier actions with a user account, each charging modifier actions having an action start time and defining a charging modifier parameter;
a receiving module (982) for receiving a service authorization request indicating a request for service reservation from a charging client;
a determination module (983) for determining a validity time period for the service reservation;
an identifier module (984) for identifying one or more of the associated charging modifier actions having the action start time within the determined validity time period;
an execution module (985) for executing the identified one or more associated charging modifier actions to activate the charging modifiers for the user account; and
a transmission module (986) for sending a service authorization response indicating a service reservation to the charging client, the service reservation based on at least one of the activated charging modifiers.

The computer 910 can also include other removable/non-removable and volatile/nonvolatile computer storage media. For example, computer 910 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 921 through a non-removable memory interface such as an interface, and a magnetic disk drive or optical disk drive can be connected to the system bus 921 by a removable memory interface, such as an interface.

A user can enter commands and information into the computer 910 through input devices such as a keyboard or a pointing device such as a mouse, trackball, touch pad, and/or other pointing device. Other input devices can include a microphone, joystick, game pad, satellite dish, scanner, or similar devices. These and/or other input devices can be connected to the processing unit 920 through user input 940 and associated interface(s) that are coupled to the system bus 921, but can be connected by other interface and bus structures, such as a parallel port, game port or a universal serial bus (USB).

A graphics subsystem can also be connected to the system bus 921. In addition, a monitor or other type of display device can be connected to the system bus 921 through an interface, such as output interface 950, which can in turn communicate with video memory. In addition to a monitor, computers can also include other peripheral output devices, such as speakers and/or printing devices, which can also be connected through output interface 950.

The computer 910 can operate in a networked or distributed environment using logical connections to one or more other remote computers, such as remote server 970, which can in turn have media capabilities different from device 910. The remote server 970 can be a personal computer, a server, a router, a network PC, a peer device or other common network node, and/or any other remote media consumption or transmission device, and can include any or all of the elements described above relative to the computer 910. The logical connections depicted in FIG. 9 include a network 971, such as a local area network (LAN) or a wide area network (WAN), but can also include other networks/buses.

When used in a LAN networking environment, the computer 910 is connected to the LAN 971 through a network interface or adapter. When used in a WAN networking environment, the computer 910 can include a communications component, such as a modem, or other means for establishing communications over a WAN, such as the Internet. A communications component, such as a modem, which can be internal or external, can be connected to the system bus 921 through the user input interface at input 940 and/or other appropriate mechanism.

In a networked environment, program modules depicted relative to the computer 910, or portions thereof, can be stored in a remote memory storage device. It should be noted that the network connections shown and described are exemplary and other means of establishing a communications link between the computers can be used.

FIG. 10 shows a computer program product, comprising a non-transitory computer readable medium and a computer program stored on the computer readable medium.

The computer program product 1000 may comprise a computer readable medium 1010 and a computer program 1020 stored on the computer readable medium.

The computer program may comprise computer readable code means, which when run in a computer being configured as an Online Charging System the computer readable code means causes the computer to perform the steps of associating one or more charging modifier actions with a user account, each charging modifier actions having an action start time and defining a charging modifier parameter and receiving a service authorization request indicating a request for service reservation from a charging client. The computer readable code means also causes the computer to perform the steps of determining a validity time period for the service reservation; identifying one or more of the associated charging modifier actions having the action start time within the determined validity time period; executing the identified one or more associated charging modifier actions to activate the charging modifiers for the user account and sending a service authorization response indicating a service reservation to the charging client, the service reservation based on at least one of the activated charging modifiers.

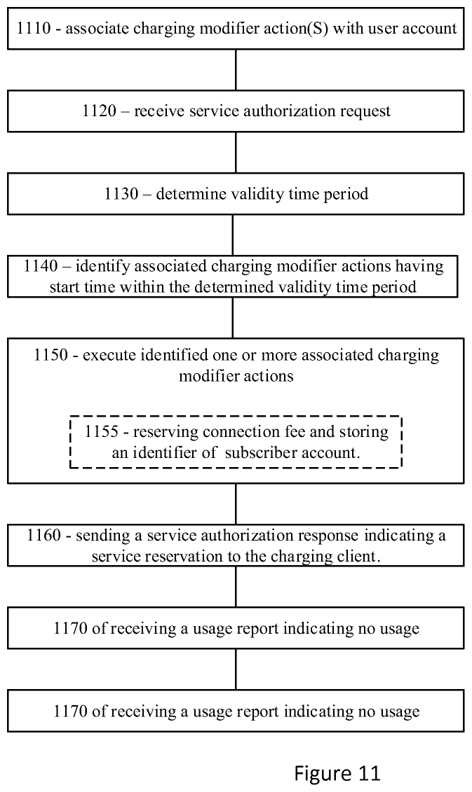

FIG. 11 shows a method performed by an Online Charging System for providing service authorization to a Charging Client. The method starts in step 1110 by associating one or more charging modifier actions with a user account wherein the charging modifier action may be a scheduled action as previously presented. Each charging modifier actions may have an action start time and defining a charging modifier parameter. The charging modifier parameter may comprise a balance of the offering, either in the form of monetary funds and/or as some other resource like data or SMS.

In step 1120 a service authorization request indicating a request for service reservation from a charging client is received. The service reservation may indicate a specific service to be provided to the subscriber—for example a voice call, an SMS or a data connection and a reservation size—or may implicitly or explicitly indicate the determination is to be made by the Online Charging System.

A validity time period for the service reservation is determined in step 1130 and in step 1140 one or more of the associated charging modifier actions having the action start time within the determined validity time period is identified.

In step 1150 the Online Charging System is executing the identified one or more associated charging modifier actions to activate the charging modifiers for the user account and sending a service authorization response indicating a service reservation to the charging client in step 1160. The service reservation based on at least one of the activated charging modifiers.

The method may include that in step 1150 when executing the identified one or more associated charging modifier actions a further step 1155 of including reserving a connection fee for the activated charging modifier from a subscriber account, and storing an identifier of the subscriber account.

The method may further include that at least one of the charging modifier actions is configured to recur at scheduled intervals.

Additionally, the method may include that step 1130 of determining the validity time-period comprises fetching a requested validity time from the received service authorization request.

In yet another example the method may include that the charging modifier further comprises a charging modifier resource value defining an amount of communication resources to be consumed by a user of the user account, such as 5 GB data traffic, 500 minutes calls, or 5000 SMS.

Another example is that the method further comprising a further step 1170 of receiving a usage report indicating no usage of a service associated with the charging modifier and a step 1180 of releasing the activated charging modifier. The step of releasing the activated charging modifier may in such case comprise removing the session reference and checking if any sessions references remains; and if no session references exists removing the reservation.

Additionally, it should be noted that as used in this application, terms such as “component,” “display,” “interface,” and other similar terms are intended to refer to a computing device, either hardware, a combination of hardware and software, software, or software in execution as applied to a computing device. For example, a component may be, but is not limited to being, a process running on a processor, a processor, an object, an executable, a thread of execution, a program and a computing device. As an example, both an application running on a computing device and the computing device can be components. One or more components can reside within a process and/or thread of execution and a component can be localized on one computing device and/or distributed between two or more computing devices, and/or communicatively connected modules. Further, it should be noted that as used in this application, terms such as “system user,” “user,” and similar terms are intended to refer to the person operating the computing device referenced above.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various exemplary combinations and subcombinations of embodiments and of the manner and process of making and using them, and shall support claims to any such combination or subcombination.

Many variations and modifications can be made to the embodiments without substantially departing from the principles of the present solution. All such variations and modifications are intended to be included herein within the scope of the present solution.

An advantage compared to prior solutions is to allow for creating the offering automatically when it is needed instead of provisioning it beforehand. The fee for the offering will be deducted regardless of there being any charging requests or not.

A further advantage is that the present solution allows creating of an offering regardless if there are any charging requests when it's time to create the offering. Thereby, it is made possible to always deduct the fee even without any usage as well as sending notification about created offering when the offering was configured to be created.

Thus, there is no need to perform any extra signaling when the new offering is created, since products that will be active later may be considered by the OCS already during the reserve phase.

The OCS is enabled to reserve fees connected to offerings as soon as we reserve a session that will occur at the time when the offers would be created and paid for. Therefore, the OCS may stop sessions from reserving cost that should be reserved for paying the offering.

By knowing that the offering will be valid at a certain time, the OCS can let a reservation for a session that will be ongoing when the offering becomes valid, also use the future offering. For example, if the system would be setup to create offerings for one month at a time, this would allow the session to be ongoing past the end of the month. If a session would then make a reservation around the end of the month and sees that no offering is valid after the end of the month, it would be required to shorten the validity of the session to the end of month. If there are many sessions that would do the same, there would be a high amount of signaling at that time, risking overloading both the network and the OCS. With the present solution the session reservations will instead see that there is a new offering created when the old one expires and are thereby able to reserve past the end of month without requiring any additional signaling.

In the present solution, creation of offerings can be handled internally inside OCS thereby avoiding the need for an external admin system to provision the offerings recurrently, thus simplifying the configuration.

1-15. (canceled)

16. A method performed by an Online Charging System for providing service authorization to a charging client, the method comprising:
associating one or more charging modifier actions with a user account, each charging modifier action having an action start time and defining a charging modifier parameter;
receiving a service authorization request indicating a request for a service reservation from the charging client;
determining a validity time period for the service reservation;
identifying one or more of the associated charging modifier actions having the action start time within the determined validity time period;
executing the identified one or more associated charging modifier actions to activate corresponding charging modifiers for the user account; and
sending a service authorization response indicating the service reservation to the charging client, wherein the service reservation is based on at least one of the activated charging modifiers.

17. The method according to claim 16, wherein executing the identified one or more associated charging modifier actions further includes reserving a connection fee for at least one of the activated charging modifiers from a subscriber account, and storing an identifier of the subscriber account.

18. The method according to claim 16, wherein at least one of the charging modifier actions is configured to recur at scheduled intervals.

19. The method according to claim 16, wherein the determining the validity time period comprises fetching a requested validity time from the service authorization request.

20. The method according to claim 16, wherein each charging modifier further comprises a charging modifier resource value defining an amount of communication resources to be consumed by a user of the user account.

21. The method according to claim 16, further comprising receiving a usage report indicating no usage of a service associated with one of the activated charging modifiers and releasing the activated charging modifier.

22. The method according to claim 21, wherein releasing the activated charging modifier comprises:
removing the session reference and checking if any session references remains; and
if no session references remain, removing the service reservation for the service.

23. An Online Charging System configured for providing service authorization to a charging client, the Online Charging System comprising:
processor circuitry; and
a memory containing instructions that, when executed by the processor circuitry, cause the Online Charging System to:
associate one or more charging modifier actions with a user account, each charging modifier action having an action start time and defining a charging modifier parameter;
receive a service authorization request indicating a request for a service reservation from the charging client;
determine a validity time period for the service reservation;
identify one or more of the associated charging modifier actions having the action start time within the determined validity time period;
execute the identified one or more associated charging modifier actions to activate corresponding charging modifiers for the user account; and
send a service authorization response indicating the service reservation to the charging client, wherein the service reservation is based on at least one of the activated charging modifiers.

24. The Online Charging System according to claim 23, wherein at least one of the charging modifier actions is configured to recur at scheduled intervals.

25. The Online Charging System according to claim 23, wherein the memory contains instructions that, when executed by the processor circuitry, causes the Online Charging System to determine the validity time period by fetching a requested validity time from the service authorization request.

26. The Online Charging System according to claim 23, wherein each charging modifier further comprises a charging modifier resource value defining an amount of communication resources to be consumed by a user of the user account.

27. A computer readable storage medium storing a computer program containing computer readable code, which when executed by a processor in a computer being configured as an Online Charging System, causes the computer to:
associate one or more charging modifier actions with a user account, each charging modifier action having an action start time and defining a charging modifier parameter;
receive a service authorization request indicating a request for a service reservation from a charging client;
determine a validity time period for the service reservation;
identify one or more of the associated charging modifier actions having the action start time within the determined validity time period;
execute the identified one or more associated charging modifier actions to activate corresponding charging modifiers for the user account; and
send a service authorization response indicating the service reservation to the charging client, wherein the service reservation is based on at least one of the activated charging modifiers.
